(19) United States
(12) Patent Application Publication
(10) Pub. No.: US 2022/0299062 A1
(43) Pub. Date: Sep. 22, 2022

(54) FASTENER AND ARRANGEMENT COMPRISING A FASTENER

(71) Applicant: NEWFREY LLC, New Britain, CT (US)

(72) Inventors: Christian KEMPF, Giessen (DE); Frank ROSEMANN, Giessen (DE)

(21) Appl. No.: 17/654,696

(22) Filed: Mar. 14, 2022

(30) Foreign Application Priority Data
Mar. 22, 2021 (EP) 21164055.2

(51) Int. Cl. F16B 37/08; F16B 21/07

(52) U.S. Cl. CPC F16B 37/0878; F16B 21/073; F16B 37/0842

(57) ABSTRACT

Arrangement with a fastener (for the fastening of a covering part to a supporting part comprising a stud, in particular a part of the body of a motor vehicle. The fastener comprises a main body with a first fastening section comprising a cavity adapted to receive the stud, the cavity longitudinally extending along a longitudinal axis, and at least one resilient locking finger having a first end, connected to the main body, and a second end, extending within the cavity, and a catching portion, adapted to engage with the stud in order to fix the fastener to the supporting part. The cavity is laterally and axially accessible, and the catching portion comprises a first and a second fin separated by a gap, wherein the first and second fins face the cavity and the fins and the gap are adapted to support a threaded shaft of a stud and/or the head of a stud.

### CROSS-REFERENCE TO RELATED APPLICATIONS

This application claims priority from European Patent Application No. 21164055.2, filed Mar. 22, 2021, the disclosures of which are incorporated herein by reference in their entirety.

### BACKGROUND OF THE INVENTION

The present invention relates to a fastener for the fastening of an attaching or covering part to a supporting part comprising a stud, in particular a part of the body of a motor vehicle. The present invention is further directed to an arrangement comprising a fastener, an attaching or covering part and a supporting part.

Fastening clips and fasteners are primarily used in automotive manufacture in order to attach mounted parts or trim parts to the body or to body parts such as door or the like. It should be possible to accomplish the attachment as easily as possible and without the aid of tools here, but the attachment should also be releasable in order to be able to carry out maintenance and repairs. On the one hand, the attachment should ensure high retention forces, but, on the other hand, it should permit non-destructive removal force. Moreover, it is frequently necessary to compensate for dimensional deviations in the parts in the region of the fasteners.

It is known to fasten an attaching or a covering part, and notably a trim strip to the body of a motor vehicle by using a stud and a fastener. A resilient clip is interlocked with a stud that is welded to a body panel.

DE102009014133 discloses a fastener for attaching a component to a stud associated with a support component comprising a base defining an opening for accepting the stud, wherein the opening has an axis and has a fastening region and an unlocking region located next to one another in a direction perpendicular to the axis. The fastening region has a resilient retaining flange configured to hold the stud in place when the stud is disposed in the fastening region, wherein the stud can be introduced into the fastening region in a direction generally parallel to the axis of the opening. The stud located in the fastening region can be displaced along a displacement path into the unlocking region by a relative movement of the stud perpendicular to the axis of the opening. In the unlocking region the stud can be removed from the opening.

EP0489505A1 is directed to a metal stud and a resilient clip. The resilient clip is provided with at least two retaining members and an aperture provided with steps corresponding to steps provided on a shoulder of the stud.

US20140064880 discloses a fastening element for fastening an attachment on a vehicle body with a basic body having a recess and multiple spring tongues.

### BRIEF SUMMARY OF THE INVENTION

It is an object of the present invention to provide a fastener that permits a high retention force while also permitting a low removal force, which can easily be used with different studs and manufactured, and more particularly a fastener which is reliable independently of the geometry of the stud.

Accordingly, the present invention provides a fastener according to claim 1. More particularly, the fastener comprises a main body with: a first fastening section comprising a cavity adapted to receive a stud, the cavity longitudinally extending along a longitudinal axis, and at least one resilient locking fingers having a first end connected to the main body, a second end extending within the cavity and a catching portion adapted to engage with the stud in order to fix the fastener to the supporting part, a second fastening section for the fastening of an attaching or covering part, characterized in that the cavity is laterally and axially accessible, such that the stud can be axially along the longitudinal axis or laterally mounted, and in that the catching portion comprises a first and a second fin separated by a gap, wherein the first and second fins face the cavity and the fins and the gap are adapted to support a threaded shaft of a stud and/or the head of a stud.

Such fastener is adapted to be used with studs having a threaded shaft or with stud having an unthreaded shaft and a flange or head. The first and second fins allow reliability and adaptability. More particularly, such fastener can be used with stud having a threaded shaft with a pitch between 0.5 and 1.8 mm, but also with a stud having a non-threaded shaft and a head with an under-head flange angle with regard to the longitudinal axis between 90 and 170 degrees. The exact same fastener can thus be used with different stud geometries.

In an embodiment the main body comprises a cap, a first lateral wall, a third lateral wall and a second lateral wall extending between the first and the third lateral walls, wherein the walls and the cap define the cavity, and the first end of the locking finger is connected to the first wall.

In an embodiment, a second resilient locking finger is provided with a first end connected to the third wall, a second end extending within the cavity and a catching portion comprising a first and a second fin separated by a gap, wherein the first and second fins face the cavity and the fins and the gap are adapted to support a threaded shaft of a stud and/or the head of a stud. The second resilient finger is for instance similar to the first resilient finger and increases the retention forces.

In an embodiment, the walls comprise an interior surface facing the cavity and an external surface opposite the internal surface, and wherein the first end of the first and/or second resilient locking finger extends from the internal surface.

In an embodiment, the locking finger extends from the main body along a finger axis which is inclined with regard to the longitudinal axis, and more particularly the locking fingers form an angle between 5 and 40 degrees with regard to the longitudinal axis.

In an embodiment, the catching portion is in the vicinity of the second end, and more particularly the catching portion is arranged between the second end and ¼ of the total length of the locking finger along the finger axis from the second end.

In an embodiment, the length of the locking finger along the finger axis is 50% to 80% of the total length of the cavity along the longitudinal axis.

In an embodiment, the locking finger has an enlarged cross-section at its first end.

In an embodiment, each fin is wedge-shaped and comprises a thin edge at one end, the thin edge facing the cavity and being adapted to contact the stud, wherein the gap has a V-shape in cross-section.

In an embodiment, the distance between the thin edge of the first fin and the thin edge of the second fin is between 0.5 mm and 2.0 mm, and preferably is of 1.8 mm. This distance allows flexibility without decreasing the retention forces. Indeed, such distance enable the use of the same fastener for different stud geometries.

In an embodiment, the second fastening section comprises a groove adapted to receive an attaching or covering part, and in particular the second fastening section comprises two grooves for receiving an attaching or covering part. First and second sections can work together to increase the retention forces.

The present invention is also directed to an arrangement comprising a fastener as disclosed above, an attaching or covering part having a C-shape and adapted to be attached to the second fastening section, and a supporting part with a stud, wherein the stud is arranged within the cavity and the fins and the gap grip the stud.

In an embodiment, a first elastic tongue extends from the main body toward the supporting part, and wherein a second elastic tongue extends from the second fastening section toward the attaching or covering part.

In an embodiment, the fastener comprises a first and a second locking finger, and wherein the fins securely hold the stud within the cavity.

### BRIEF DESCRIPTION OF THE DRAWINGS

A specific embodiment of the present invention will now be described, by way of example only and with reference to the accompanying drawings, of which:

FIG. 1 shows a covering part, a supporting part and a fastener receiving a threaded stud with a coarse thread.

FIG. 2 shows a covering part, a supporting part and the fastener of FIG. 1 receiving a threaded stud with a metric thread.

FIG. 3 shows a covering part, a supporting part and the fastener of FIG. 1 receiving a non-threaded stud with a head.

### DETAILED DESCRIPTION OF THE PREFERRED EMBODIMENTS

Corresponding reference numerals indicate corresponding parts throughout the several views of the drawings.

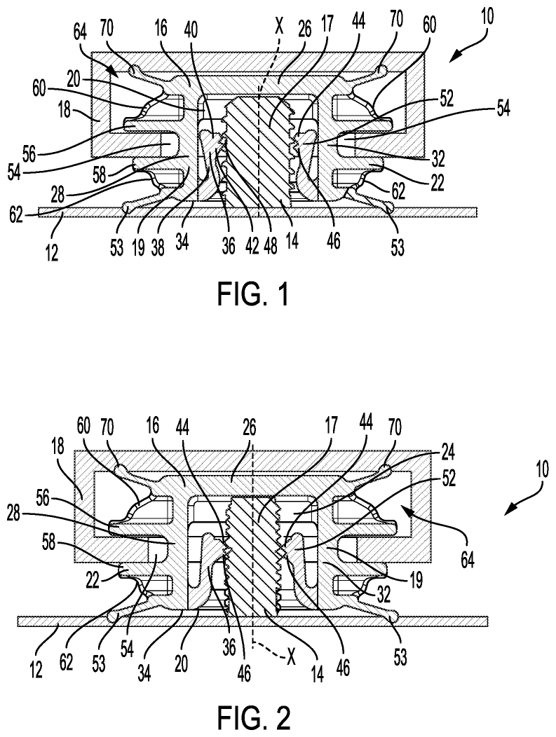

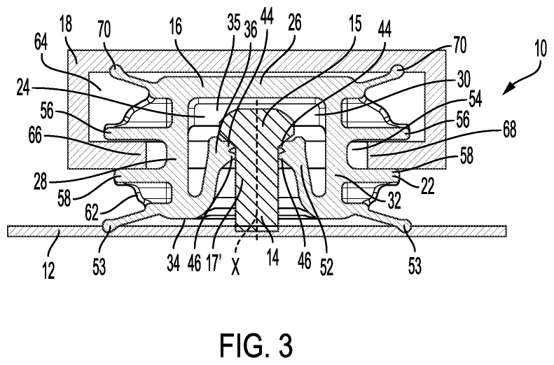

FIG. 1, FIG. 2 and FIG. 3 show an arrangement 10 comprising a supporting part 12 with a stud 14, a fastener 16 connected to the stud 14 and an attaching or covering part 18 connected to the fastener 16.

In FIG. 1 the stud 14 comprises a threaded shaft 17 with a coarse thread, for instance a T6 or T5 thread. In FIG. 2, the stud 14 comprises a threaded shaft 17 with a metric thread, for example a M6. In other embodiments, other threads may be implemented. More particularly, as better described below, the threaded shaft of the stud has a pitch between 0.5 and 1.8 mm.

In another embodiment, as depicted in FIG. 3, the shaft 17′ of the stud 14 is non-threaded, and the stud 14 comprises a head 15 with an under-head flange angle with regard to the longitudinal axis between 90 and 170 degrees.

The stud 14 is for example welded or glued to the supporting part 12.

The fastener 16 is made of plastic material. The fastener 16 is a one-part fastener. The fastener 16 comprises a main body 19 with a first fastening section 20 adapted to be connected to the stud and a second fastening section 22 adapted to be connected to the covering part 18.

The first fastening section 20 comprises a cavity 24 adapted to receive the stud 14. The cavity 24 extends longitudinally along a longitudinal axis X. The cavity 24 is for instance delimited by a cap 26, a first wall 28, a second wall 30 and a third wall 32. The second wall 30 extends between the first and the third wall 28, 32. The cap 26 extends on the top of the first, second and third wall 28, 30, 32. The cavity 24 is axially and laterally accessible. The cavity is axially accessible through the bottom 34 of the main body 19, the bottom 34 being opposite the cap 26. The cavity 24 is further laterally accessible through the opening 35 provided between the first and third walls 28, 32. In other words, the cavity is not closed by a fourth wall. The fourth lateral side of the cavity 24 is open. The cavity 24 is for example parallelepipedal. But, in another embodiment, the cavity may be cylindrical, frustroconical, . . . . The height of the cavity along the longitudinal axis X is greater than the length of the stud 14.

A resilient locking finger 36 extends within the cavity 24. The resilient locking finger 36 comprises a first end 38 extending from the main body 19 and a second end 40. The first end 38 extends from the bottom or free edge of the first wall 28. The first end 38 comprises an enlarged cross-section with regard to the rest of the resilient locking finger. The enlarged cross section prevent to form a weak portion. Indeed, the resilient locking finger is movable between a rest position and a mounted position. In the mounted position, the resilient locking finger 36 is elastically deformed and the first end, connected to the main body has to withstand a higher mechanical stress than the rest of the resilient locking finger 36. The second end 40 is a free end. The second end extends in the cavity 24. The resilient locking finger 36 extends along a finger axis and, in a rest position of the resilient locking finger 36, the finger axis and the longitudinal axis X form an angle between 5 and 40 degrees. The length of the locking finger 36 along the finger axis is 50% to 80% of the total length of the cavity along the longitudinal axis X. The resilient locking finger 36 comprises a catching portion 42 adapted to engage with the stud 14 in order to fix the fastener to the supporting part, and more particularly to interconnect stud and fastener. The catching portion 42 is in the vicinity of the second end 40, and more particularly the catching portion 42 is arranged between the second end 40 and ¼ of the total length of the locking finger along the finger axis from the second end. The catching portion 42 comprises a first fin 44 and a second fin 46. The first and the second fins are separated by a gap 48. Each fin is wedge-shaped and comprises a thin edge 50 at one end, the thin edge facing the cavity and being adapted to contact the stud, wherein the gap has a V-shape in cross-section. The gap forms an angle A in cross section in the range of 2 to 80 deg. The distance between the thin edge 50 of the first fin 44 and the thin edge 50 of the second fin 46 is between 0.5 mm and 2.0 mm, and preferably is of 1.8 mm. Such distance notably allows to support a threaded shaft of a stud with a pitch between 0.5 and 1.8 mm and/or the flange of a stud having a under-head flange angle with regard to the longitudinal axis between 90 and 170 degrees.

Actually the resilient locking finger is a first resilient locking finger 36, and a second resilient locking finger 52 is provided. The second resilient locking finger 36 is similar to first resilient locking finger. The second resilient locking finger 36 comprises a first end 38 extending from the main body 19 and a second end 40. The first end extends from the bottom of the third wall. The first end 38 comprises an enlarged cross-section with regard to the rest of the second resilient locking finger, in order to withstand a higher mechanical stress. The second end 40 is a free end. The second end extends in the cavity. The second resilient locking finger 50 extends along a finger axis and, in a rest position of the second resilient locking finger, the finger axis and the longitudinal axis form an angle between 5 and 40 degrees. The length of the second resilient locking finger along the finger axis is 50% to 80% of the total length of the cavity along the longitudinal axis. The second resilient finger comprises a catching portion 42 adapted to engage with the stud in order to fix the fastener to the supporting part. The catching portion 42 is in the vicinity of the second end 40, and more particularly the catching portion 42 is arranged between the second end 40 and ¼ of the total length of the second resilient locking finger along the finger axis from the second end. The catching portion 42 comprises a first fin 44 and a second fin 46. The first and the second fins are separated by a gap 48. Each fin is wedge-shaped and comprises a thin edge 50 at one end, the thin edge facing the cavity and being adapted to contact the stud, wherein the gap has a V-shape in cross-section. The gap forms an angle A in cross section in the range of 2 to 80 deg. The distance between the thin edge 50 of the first fin 44 and the thin edge 50 of the second fin 46 is between 0.5 mm and 2.0 mm, and preferably is of 1.8 mm. Such distance notably allows to support a threaded shaft of a stud with a pitch between 0.5 and 1.8 mm and/or the flange of a stud having a under-head flange angle with regard to the longitudinal axis between 90 and 170 degrees.

First and second resilient fingers 36, 50 are facing each other. In another embodiment, a third resilient finger (not represented), extending from the second wall 30 may be provided.

In FIG. 1 and FIG. 2, the fins and the gap cooperate with the thread of the shaft to hold the stud, notably along the longitudinal axial. In FIG. 3, the fins 44, 46 rest on the head 15 of the stud. More particularly the head 15 has an under head flange and the fins 44, 46 rest on the under-head flange of the stud 14. Thus, the resilient locking fingers 36, 52 lock the stud 14, independently of the type of stud.

At the outskirts of the cavity 24, for instance extending from the edge of the first and/or third wall, a first elastic tongue 53 may be provided. Actually a first first elastic tongue 53 may be provided extending from the first wall and a second first elastic tongue 53 may be provided from the third wall. These allow tolerance compensation.

The second fastening section for the fastening of an attaching or covering part comprises as depicted in the FIG. 1 to FIG. 3 a groove 54. The groove 54 is adapted to receive the attaching or covering part. The groove 54 is for instance arranged on the outside surface of the main body, opposite the cavity 24. The groove 54 is sensibly arranged in the middle of the first and/or third wall 28, 32. The groove 54 is formed with a first and a second protrusion 56, 58. The protrusions 56, 58 extend from the wall and are spaced apart. The protrusions 56, 58 are for instance parallel to each other. The first protrusion 56 may be connected to the cap 26 through a reinforcement portion 60. The second protrusion 58 may be connected to the edge of the first or third wall 28, 32 through a reinforcement portion 62. The first protrusion 56 is for instance longer than the second protrusion 58.

For instance, the attaching or covering part 18 has a C-shape with an aperture 64 and two free ends 66, 68, and the second fastening section 22 comprises two grooves 54, each groove 54 receiving a free end 66, 68 of the attaching or covering part 18. The aperture 18 received the cap 26 of the main body 19. The first and second fastening sections 20, 22 may cooperate together as notably described in EP19216707.0.

The cap 26 of the main body 19 may be provided on its outside surface, opposite the cavity, with a second elastic tongue 70. The second elastic tongue 70 extends from an edge of the cap 26.

The fastener 16 as depicted in FIG. 1 to Fig. has a symmetrical plane. However, in another embodiment, the fastener 16 may not be provided with a symmetrical plane.

In an assembled position, the fastener 16 being mounted on the stud, the first elastic tongue(s) extend(s) toward the supporting part. The second elastic part extends toward the attaching or covering part. First and second elastic tongues are provided to compensate tolerance play.

As previously mentioned, the cavity 24 is axially and laterally accessible. More particularly the fastener 16 can be mounted on the stud by a relative movement of the stud along the longitudinal axis X until the stud fully sits in the cavity and the resilient locking finger(s) support the stud. In such position, the first elastic tongue rests on the supporting part.

In order to remove the fastener 16 from the stud 14, without damaging the fastener 16, a relative movement of the stud 14 perpendicular to the longitudinal axis X is realized.

Although exemplary embodiments of the present invention have been shown and described, it will be appreciated by those skilled in the art that changes may be made to these embodiments without departing from the principles and spirit of the invention, the scope of which is defined in the appended claims and their equivalents.

What is claimed is:

1. A fastener for the fastening of a covering part to a stud, the stud having a threaded shaft and a head, and wherein the fastener comprises: a main body including:
a first fastening section comprising a cavity adapted to receive the stud, the cavity longitudinally extending along a longitudinal axis, and a first resilient locking finger having a first end, connected to the main body, a second end, extending within the cavity, and a catching portion, adapted to engage with the stud in order to fix the fastener to the stud,
a second fastening section for the fastening of the covering part; and
wherein the cavity is laterally and axially accessible, such that the stud can be mounted axially along the longitudinal axis or laterally into the cavity, and the catching portion comprises a first fin and a second fin separated by a gap, wherein the first fin and second fin face the cavity and the first and second fins and the gap are adapted to support the threaded shaft of the stud or the head of the stud.

2. The fastener according to claim 1, wherein the main body further comprises a cap, a first lateral wall, a third lateral wall and a second lateral wall extending between the first later wall and the third lateral wall; and wherein the first, second, and third lateral walls and the cap define the cavity, and the first end of the first resilient locking finger is connected to the first lateral wall.

3. The fastener according to claim 2, and further comprising a second resilient locking finger connected to the third wall.

4. The fastener according to claim 2, wherein the first, second, and third lateral walls comprise an interior surface facing the cavity and an external surface opposite the internal surface, and wherein the first end of the first resilient locking finger extends from the internal surface.

5. The fastener according to claim 1, wherein the first resilient locking finger extends from the main body along a finger axis which is inclined with regard to the longitudinal axis and forms an angle between 5 and 40 degrees with regard to the longitudinal axis.

6. The fastener according to claim 5, wherein the catching portion is located between the second end and ¼ of the total length of the first resilient locking finger along the finger axis from the second end.

7. The fastener according to claim 6, wherein the total length of the first resilient locking finger along the finger axis is from 50% to 80% of a total length of the cavity along the longitudinal axis.

8. The fastener according to claim 1, wherein the first resilient locking finger has an enlarged cross-section at the first end.

9. The fastener according to claim 1, wherein each of the first fin and the second fin are wedge-shaped with a thin edge, the thin edge facing the cavity and being adapted to contact the stud, and wherein the gap has a V-shape in cross-section.

10. The fastener according to claim 9, wherein a distance between the thin edge of the first fin and the thin edge of the second fin is between 0.5 mm and 2.0 mm.

11. The fastener according to claim 1, wherein the second fastening section further comprises a groove adapted to receive the covering part.

12. An assembly comprising:
a supporting part with a stud, and the stud includes a threaded shaft and a head;
a covering part having a C-shape; and
a fastener comprising: a main body including:
a first fastening section comprising a cavity adapted to receive the stud, the cavity is longitudinally extending along a longitudinal axis, and a first resilient locking finger having a first end connected to the main body, a second end extending within the cavity and a catching portion adapted to engage with the stud in order to fix the fastener to the stud,
a second fastening section for the fastening of the covering part; and
wherein the cavity is laterally and axially accessible, such that the stud can be mounted axially along the longitudinal axis or laterally, and the catching portion comprises a first fin and a second fin separated by a gap, wherein the first fin and second fin face the cavity and the first and second fins and the gap are adapted to support the threaded shaft of the stud or the head of the stud; and
wherein:
the covering part having a C-shape is attached to the second fastening section, and
the stud is arranged within the cavity, and the fins and the gap grip the stud.

13. The assembly according to claim 12, wherein a first elastic tongue extends from the main body toward the supporting part, and wherein a second elastic tongue extends from the second fastening section toward the covering part.

14. The assembly according to claim 12, wherein the fastener further comprises a second resilient locking finger, and the fins securely hold the stud within the cavity.
